(19) United States
(12) Patent Application Publication
(10) Pub. No.: US 2016/0149779 A1
(43) Pub. Date: May 26, 2016

(54) SYSTEM STATE MESSAGE IN SOFTWARE DEFINED NETWORKING

(71) Applicants: Rangaprasad SAMPATH, Bangalore, Karnataka (IN); Venkatavaradhan DEVARAJAN, Bangalore, Karnataka (IN); Vijay KANNAN, Bangalore, Karnataka (IN); HEWLETT-PACKARD DEVELOPMENT COMPANY, L.P., Houston, TX (US)

(72) Inventors: Rangaprasad SAMPATH, Bangalore (IN); Venkatavaradhan DEVARAJAN, Bangalore (IN); Vijay KANNAN, Bangalore (IN)

(21) Appl. No.: 14/893,205

(22) PCT Filed: Aug. 7, 2013
(86) PCT No.: PCT/IN2013/000486

§ 371 Date: Nov. 23, 2015

(30) Foreign Application Priority Data
May 27, 2013 (IN) 1591/DEL/2013

(51) Int. Cl. H04L 12/26; H04L 12/24

(52) U.S. Cl. CPC H04L 43/065; H04L 43/0817; H04L 41/085; H04L 41/06

(57) ABSTRACT

A method for a network device reporting system state to a controller, the method comprising a network device:
determining a system state of the network device;
constructing a system state message including a header and a payload; the header including a message type field indicating that the message relates to system state; the payload including a system state notification comprising a system state type field indicating a type of system state which is being communicated, and a value field indicating a system state value; and
sending the system state message from the network device to the controller over a software defined networking (SDN) protocol channel.

### BACKGROUND

A network device, such as a switch or router, typically includes a control plane which makes decisions about where network traffic is sent and a data plane which carries out the physical forwarding of data to the selected destination. Software defined networking (SDN) is an approach in which the control plane and the data plane are handled by physically separate devices.

A SDN network device includes a forwarding table and forwards traffic flows based on the contents of the forwarding table. The SDN controller acts as the control plane and carries out higher level functions. For example, the SDN controller may instruct adding entries to, or deleting entries from, the SDN network device's forwarding table. The OpenFlow Protocol (OFP) is one example a SDN protocol which is currently gaining acceptance in the marketplace.

### BRIEF DESCRIPTION OF THE DRAWINGS

Examples will now be described, by way of non-limiting example only, with reference to the accompanying drawings, in which:

FIG. 1 shows an example of a network device and controller according to the present disclosure;

FIG. 2 shows an example method for a network device according to the present disclosure

FIG. 3 shows an example structure for a network device according to the present disclosure;

FIG. 4A shows an example system state message according to the present disclosure;

FIG. 4B shows another example system state message according to the present disclosure;

FIG. 4C shows another example system state message according to the present disclosure;

FIG. 5 shows an example system state notification according to the present disclosure;

FIG. 6 shows an example use of a bulk port status notification according to the present disclosure;

FIG. 7 shows another an example system state notification according to the present disclosure;

FIG. 8 shows another an example system state notification according to the present disclosure;

FIG. 9 shows another an example system state notification according to the present disclosure;

FIG. 10 shows another an example system state notification according to the present disclosure;

FIG. 11 shows an example system state message according to the present disclosure, in which example the system state message includes a plurality of system state notifications;

FIG. 12 shows another an example system state notification according to the present disclosure;

FIG. 13 shows another an example system state notification according to the present disclosure;

FIG. 14 shows another an example system state notification according to the present disclosure;

FIG. 15 shows another an example system state notification according to the present disclosure;

FIG. 16 shows an example message for communicating that a network device has capability to handle a system state message according to the present disclosure;

FIG. 17A shows an example of a controller according to the present disclosure;

FIG. 17B shows an example structure for one of the parts shown in FIG. 17A;

FIG. 18A shows an example of a forwarding table of a network device according to the present disclosure;

FIG. 18B shows an example of the forwarding table of 18A after modification by a controller in response to a system state notification message; and

FIG. 19 shows an example of a network including a controller and a plurality of network devices according to the present disclosure.

### DETAILED DESCRIPTION

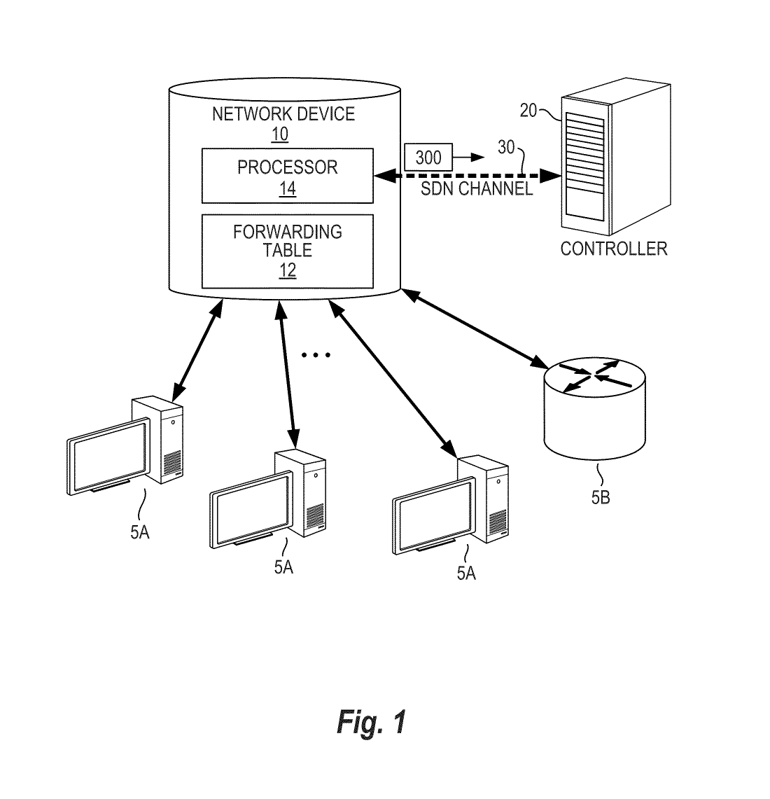

FIG. 1 is a schematic diagram showing an example of an SDN network device 10 and an SDN controller 20 according to the present disclosure. Both the SDN network device 10 and SDN controller operate according to a SDN protocol, such as the OpenFlow Protocol.

The SDN network device 10 has a forwarding table 12 and a processor 14. The SDN network device 10 receives traffic flows from client devices 5A or other network devices 5B, and forwards the traffic flows according to the contents of its forwarding table 12. A traffic flow is a stream of one or more packets carrying data from a source to a destination. The SDN network device 10 is able to detect packets belonging to a particular flow based on the packet's the source address, destination address and/or other criteria. Each entry in the forwarding table 12 may correspond to a particular traffic flow.

The processor 14 runs a SDN channel manager, which is a functional module that communicates with the SDN Controller 20 over a SDN protocol channel 30. In the context of this disclosure, a SDN protocol channel is a channel which is used for communicating traffic flows and flow forwarding decisions between a SDN network device and a SDN controller. One example of an SDN protocol channel is the OpenFlow Protocol Channel. The SDN protocol channel 30 may operate over a direct connection between the SND network device and SDN controller, or an indirect connection over a number of nodes in a network. The physical connections which support the SDN channel may be LAN connections, WAN connections, wired, optical or wireless connections etc. The SDN protocol channel may encapsulate packets in a tunnel between the SDN network device and SDN controller. In some cases the tunnel may be a secure tunnel using SSL or another encryption protocol.

The SDN controller 20 acts as a control plane for the SDN network device 10. The SDN controller 20 may instruct adding entries to, or deleting entries from, the SDN network device's forwarding table 12. The network device's forwarding table may be populated on a proactive basis or a reactive basis, or a combination of both. With pro-active methods the network device, or controller, pre-populates the forwarding table by entering frequently used flows ahead of time, while in re-active methods the controller adds flow entries as they are needed.

For instance, if the SDN network device 10 receives a flow which cannot be forwarded based on the current contents of its forwarding table, then it may send a message through the SDN channel to the SDN controller to request help to determine how the flow should be forwarded. In response the SDN controller may send forwarding instructions back to the SDN network device and/or instruct addition or change of an entry in the SDN network device forwarding table 12.

As it is capable of communicating flow forwarding decisions, the SDN protocol channel 30 is generally quite responsive and capable of communicating data relatively quickly. The SDN protocol may be a relatively simple and lightweight protocol.

According to the present disclosure, a network device 10 reports system state information of the network device to a controller 20 by sending a system state message 300 over the software defined networking (SDN) protocol channel 30. The system state message 300 may include a header indicating that the message relates to system state and a payload. The payload may include a system state type field indicating the type of system state information and a value field providing system state information.

As the system state message includes a system state type field as well as a system state value field, the approach is flexible and not limited to just one type of system state. It may be used to communicate a variety of system state information and in some cases may communicate relatively complicated changes in system state.

Furthermore, as the network device communicates system state information to the SDN controller over the SDN protocol channel, it may be delivered relatively quickly. In the context of this disclosure, a SDN protocol channel is a channel which is used for communicating traffic flows and flow forwarding decisions between a SDN network device and a SDN controller. The controller could use other methods for obtaining system state, such as OF-Config or LDPP. However, OF-Config and LDPP are not SDN Protocols and as they are not designed for communicating traffic flows and flow forwarding decisions, they tend to be more cumbersome and slower than SDN protocols. Using a SDN Protocol, such as Open Flow Protocol to communicate the system state information enables the controller to be notified of changes quickly.

The SDN controller may receive a system state message and determine whether to change a network forwarding policy based on information contained in the received system state message. For example if a port of a network device is down, or capacity is reached, or a component fails etc, then it may be desirable to change the forwarding policy to forward flows out of different ports or to direct traffic away from that network device. The SDN controller may respond by sending an instruction to modify the forwarding table of the network device 10 which sent the system state information, or by changing the forwarding table of another network device.

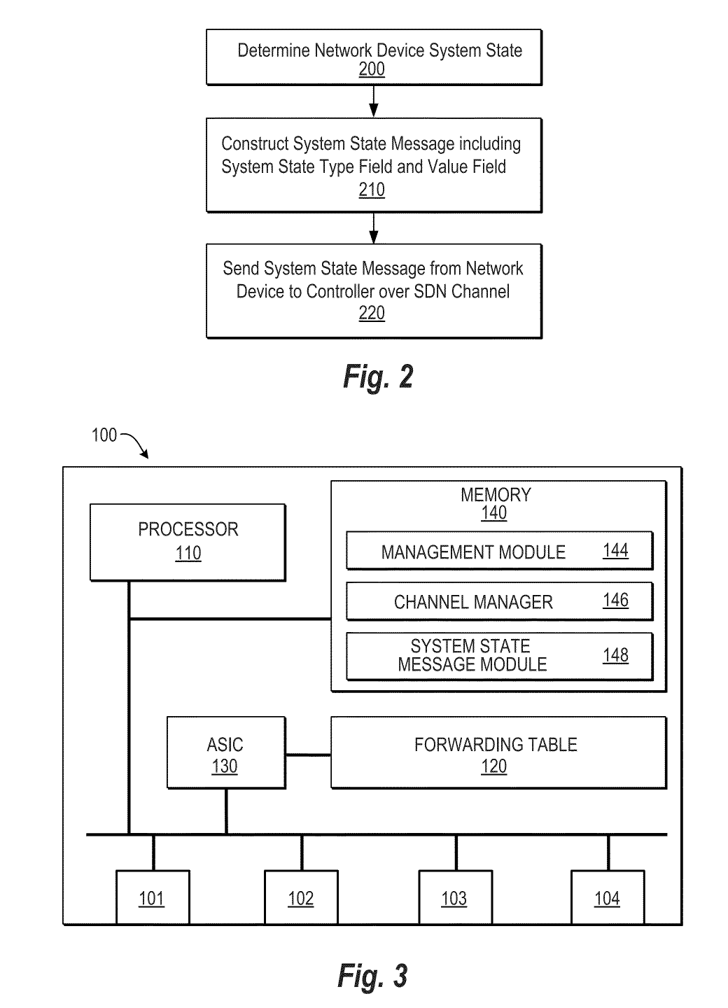

FIG. 2 is a flow diagram showing a method according to one example of the present disclosure.

At block 200 a system state of network device 10 is determined.

In one example, the determining of system state is a result of, or response to, the network device itself detecting that a particular aspect of the system state has changed or a result of a periodic check carried out by the network device. This enables the network device to quickly discover and communicate changes in system state as it does not need to wait for a request for information from the controller.

In other examples the determining of system state may be in response to a request for system state information from the SDN controller, or carried out when the SDN network device first connects to the SDN controller over the SDN protocol channel.

The system state may for example relate to a port status, a component failure, a system utilization (load) level or configuration etc. The system state may include any one of the following attributes: a port status other than simple up down status of a single port, multiple port status, port renumber operation, port BFD status, port VLAN, network device VLAN, component failure, component utilization, network device utilization, PoE capability, status of a component other than a port, or a network device configuration or capability etc. The determining may involve determining just one system state attribute or several system state attributes.

At block 210 the network device constructs a system state message based on the determined system state. In some examples the network device constructs a system state message regardless of whether the system state has changed or not, in other examples the network device only constructs a system state message in response to determining that the system state has changed.

The system state message includes a header and a payload. The header may comprise a message type field indicating that the message relates to system state. The payload includes a system state notification including a system state type field indicating a type of system state which is being communicated, a value field indicating a system state value. One system state notification or several system state notifications may be sent in the same message.

At block 220 the network device sends a system state message to the SDN controller 20 over SDN protocol channel 30.

FIG. 3 shows one example of a SDN network device. The SDN device 100 comprises a plurality of communication ports 101, 102, 103, 104 which may for instance be Ethernet ports, optical ports, fiber channel ports etc; a processor 110 and a forwarding table 120. The forwarding table is stored in a non-transitory volatile or non-volatile storage medium or memory. The forwarding table may for instance be stored in a TCAM (ternary content addressable memory), other content addressable memory, or other semiconductor device or memory such as flash memory, RAM, EEPROM, or magnetic or optical disk such as an internal or removable hard drive etc. The SDN device further comprises an ASIC 130 which is to handle flow forwarding operations based on the contents of the forwarding table 120.

The SDN network device further comprises a memory 140 which is accessible by the processor 110. The memory 140 stores modules of machine readable instructions executable by the processor including a network device management module 144, a channel manager 146 and a system state message module 148. The memory in which the machine readable instructions are stored may be a volatile or non-volatile memory or storage media including by way of example semiconductor memory devices, e.g., EPROM, EEPROM, DRAM and flash memory devices; magnetic disks, e.g., internal hard disks or removable disks; magneto optical disks; and CD ROM and DVD-ROM disks.

The forwarding table 112 may be pre-populated or populated by the processor on the basis of instructions from a module in the memory 140 or instructions from an SDN controller. The network management module 144 acts as a management plane for the network device and is capable of determining system state. It may carry out the determining block 200 of FIG. 2. The system state message module 148 includes instructions to construct a system state notification based on a determined system state. It may carry out the function of block 210 of FIG. 2. The system state message module may include or have access to a system state notification library defining the format and structure of a plurality of system state Type-Length-Values (TLVs) which may be used in system state notifications sent over the SDN protocol channel. A TLV is a format of message which includes a type field, a length field and a value field and may be used in networking to communicate information. The network device channel manager 146 takes care of communication between the SDN network device and a SDN controller over a SDN protocol channel. It may carry out the sending function of block 220 of FIG. 2.

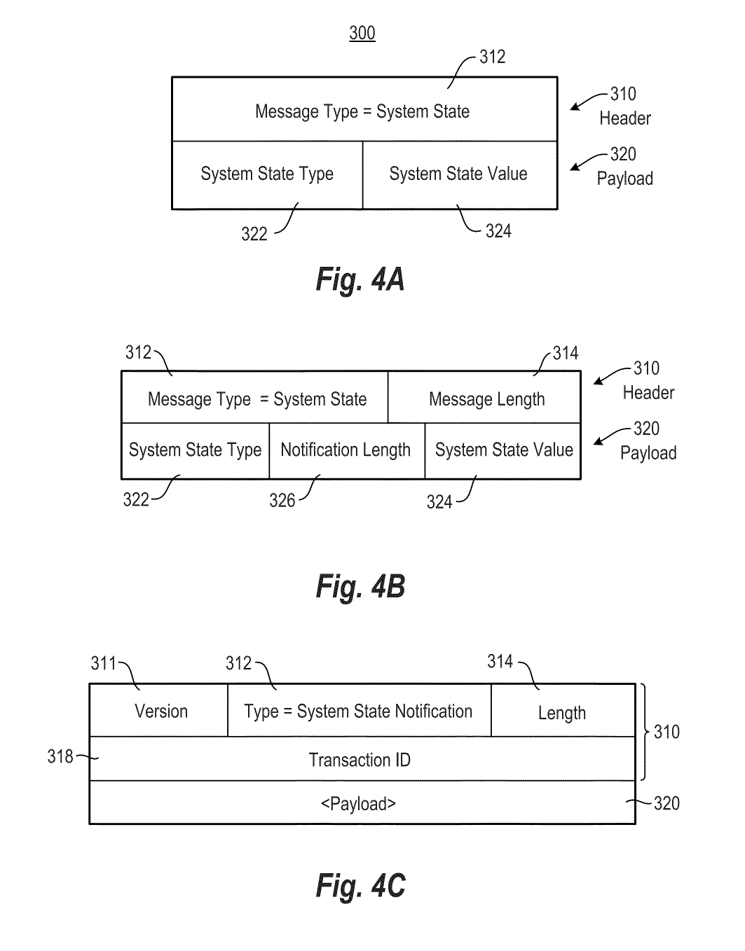

FIG. 4A shows a general structure of a system state message 300 according to the present disclosure. The message includes a header 310 and a payload 320. The header includes a message type field 312 which indicates that the message relates to system state.

The payload 320 includes at least one system state notification. While only one system state notification is shown in FIG. 4A, the payload may include several system state notifications as will be explained in more detail later. The system state notification includes a system state type field 322 and a system state value field 324 including information relating to the system state type indicated in field 322. The system state value field 324 may be one field or may include several sub-fields. This combination of system state type field and system state value field is thus very flexible and capable of communicating many different types of system state.

The contents of the various fields may be in numeric format, such as binary or hexadecimal codes, which each denote a particular message type, system state type and value etc. The formats of the system state notifications and any codes to be used may be stored in a system state notification library on, or accessible to, the network device and controller or may be programmed into the network device and controller software or firmware.

The SDN network device may select a system state notification from among a plurality of possible system state notifications based on the system state to be communicated. For instance the SDN network device may determine a particular system state attribute has changed and thus want to communicate this to the SDN controller. For example the network device may select a system state notification having a format designed for communicating a particular system state attribute and having a system state type field indicating that system state attribute and construct the system state notification by populating the value field according to determined system state of the network device relating and populating the system state notification length field (if any) accordingly. The system state message may then be constructed by adding a system state message header and using the system state notification or several system state notifications as a payload.

FIG. 4B shows another example of a general structure for a system state message 300. It is similar to that shown in FIG. 4A, but also includes a message length field 314 and a system state notification length field 326.

The message length field and system state notification length field may be useful as a system state message and system state notification may vary in length depending on the information being communicated. The length field helps the controller to know when a system state message, or particular system state notification within a system state message, has ended. Instead of, or in addition to, a length field it may be possible for some types of notification to have a standard length or to use a notification end field. Likewise a system state message may have an end section (discussed in more detail later).

FIG. 4C illustrates a specific example of a header of system state message using the OpenFlow Protocol in more detail. In addition to the fields already described with reference to FIG. 4B, the header in FIG. 4C includes an OpenFlow Protocol (OFP) version field 311 which indicates that the message is in accordance with the OFP and may also indicate the version of OFP being used, and a transaction ID field 318 indicating a transaction number for the message. The message includes a payload including at least one system state notification which may for instance have a structure as shown in FIG. 4A or FIG. 4B.

Several examples of system state notifications will now be described.

System State Relating to a Network Device Port

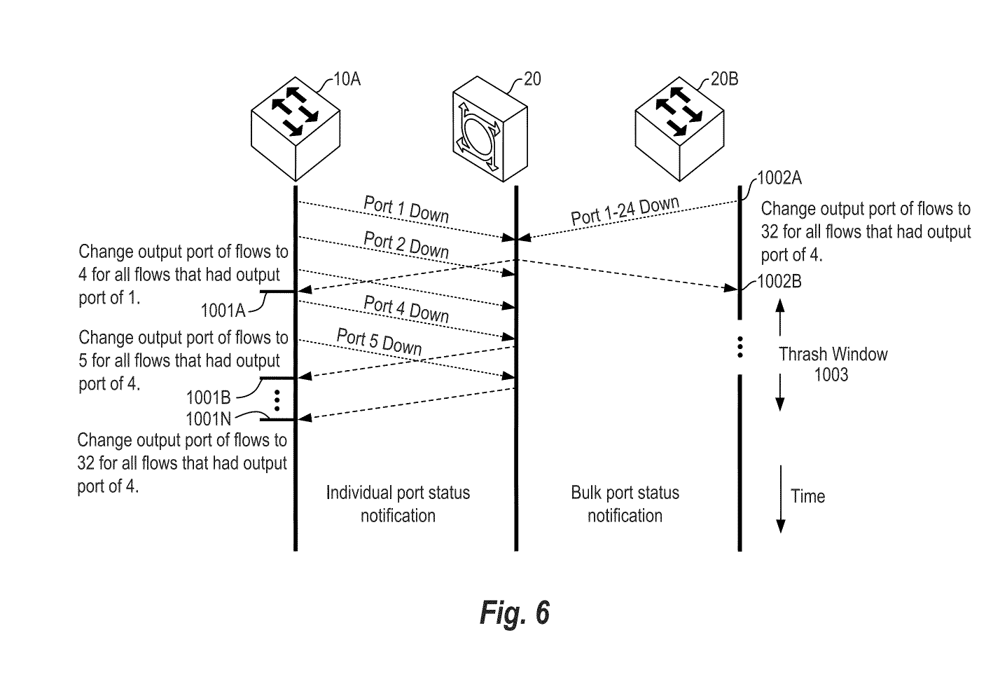

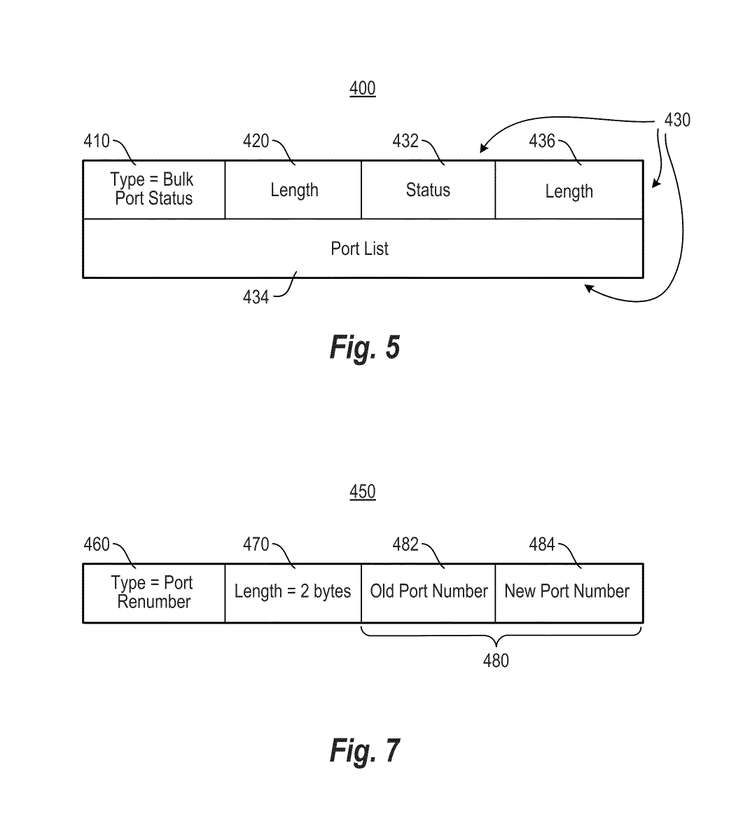

FIG. 5 shows an example of a bulk port status notification 400. Rather than indicating the status of one port, it indicates the status of a plurality of ports. For instance it may communicate the status of all ports whose status has changed, or all ports whose status is down. This information can then be communicated efficiently to the SDN controller in a single message.

The notification includes a system state type field 410 indicating that the notification is a bulk port status notification, a value field 430 containing information relating to the status of a plurality of ports and may also include a notification length field 420 indicating the length of the notification. The value field may include a port status sub-field 432 indicating either an UP status or a DOWN status for the ports and a port list sub-field 434 indicating the port numbers which the status in the status sub-field applies to. The value field 430 may also include a reason code sub-field 436 indicating a reason for the port status.

FIG. 6 is a network diagram timeline showing communication of port status in action. The left side of the diagram shows the situation in which a bulk port status notification is not used and instead network device 10A communicates the status of each port individually in a separate message. Thus a separate port down message is sent for each of port 1, port 2, port 3 etc and a total of 24 port down messages may be sent if ports 1-24 are down. For simplicity only the first 5 port down messages are shown in FIG. 6. The controller responds to the port down messages by instructing modification of the forwarding table of network device 10A. However, as the port status is not received in bulk in a coherent fashion, the controller may not be able to formulate a suitable strategy. For example, in this example at time point 1001A the network device 10A is instructed by the controller to change the output port of flows previously outputting to port 1 to port 4. This is because at the time the controller 20 issues this instruction it does not realize that port 4 is down. Similarly at time point 1001B the network device 10A may be instructed to change the output port of flows that output to port 4 to port 5, as at this point the controller does not realize that port 5 is down. This process may continue with further instructions from the controller to change the output port. For simplicity not all of this thrashing between output ports is shown in FIG. 6. In the illustrated example, at time point 1001N the network device is instructed to change output of flows currently outputting to port 4 to port 32 which is currently up. In contrast on the right side of the diagram network device 10B sends a single message with a bulk port status notification to the controller at time point 1002A. At time point 1002B the controller responds by instructing the network device to change the output of flows which were to ports 1-24 to new ports which are not down (e.g. flows being forwarded through port 4 may be changed to be forwarded through port 32 instead). This is more efficient and saves a period of time illustrated by arrows 1003 during which the network device on the left is ‘thrashing’ by continuously updating its forwarding table to output to ports which are already down which necessitates further messages to the controller and forwarding table modification.

FIG. 7 shows an example of a port re-number notification 450. It includes a system state type field 460 indicating the notification relates to port re-numbering, a value field 480 and may also include a notification length field 470 indicating the length of the notification. The value field 480 may include an old port number sub-field 482 and a new port number sub-field 484. The notification may thus communicate that a port number listed in the old port number sub-field has changed to the port number listed in the new port number sub-field.

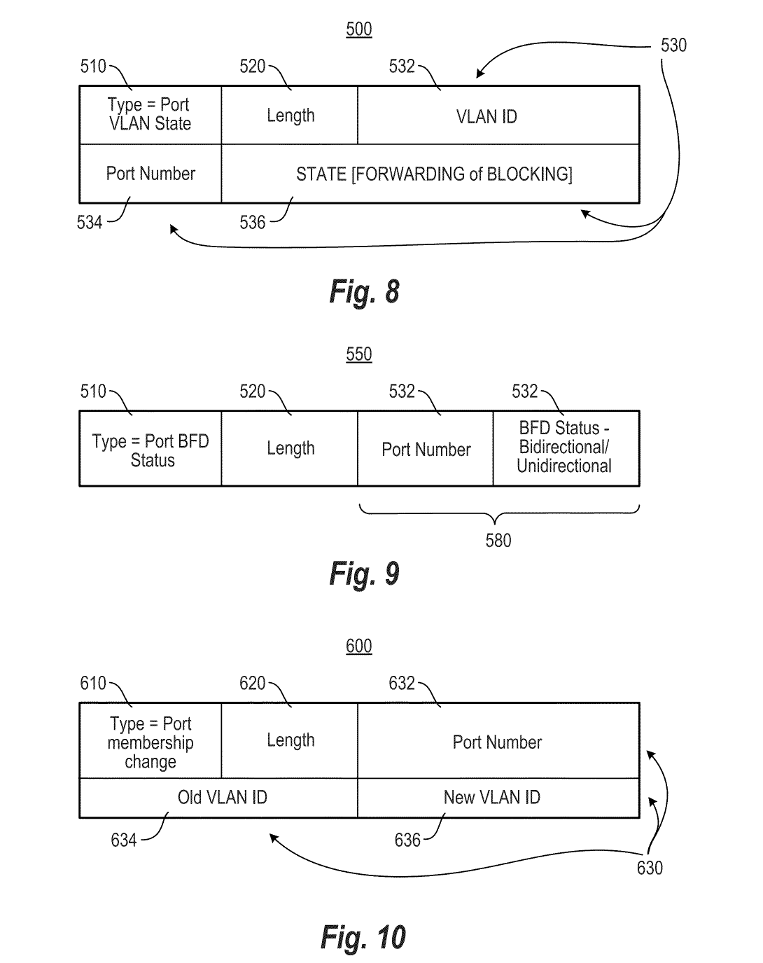

FIG. 8 shows an example of a port VLAN state notification 500. It includes a system state type field 510 indicating that it relates to port VLAN state and a value field including a state value field 530. It may also include a length field 520 indicating the length of the notification. The state value field may include a VLAN ID sub-field 532, a port number sub-field 534 and a state sub-field 536 with a value indicating whether the port indicated in the port number field 534 is forwarding or blocking the VLAN indicated in the VLAN ID sub-field 536.

FIG. 9 shows an example of a port Bi-Directional Forwarding Detection (BFD) Status notification 550. It includes a system state type field 560 indicating that it relates to a port BFD status and a value field 580. It may also include a length field 570 indicating the length of the notification. The value field 580 may include a port number sub-field 582 indicating a port number and a BFD status field 584 indicating either that the port indicated in the port number field is Bi-directional or Uni-directional.

FIG. 10 shows an example of a VLAN port membership notification 600. It includes a system state type field 610 indicating that it relates to a port VLAN membership change and a value field. It may also include a length field 620 indicating the length of the notification. The value field may include a port number sub-field 632 indicating the port for which a VLAN has changed, an old VLAN ID sub-field 534 indicating the port's old VLAN ID and a new VLAN ID sub-field 534 indicating the port's new VLAN ID.

Combining Multiple System State Notifications in a Single Message

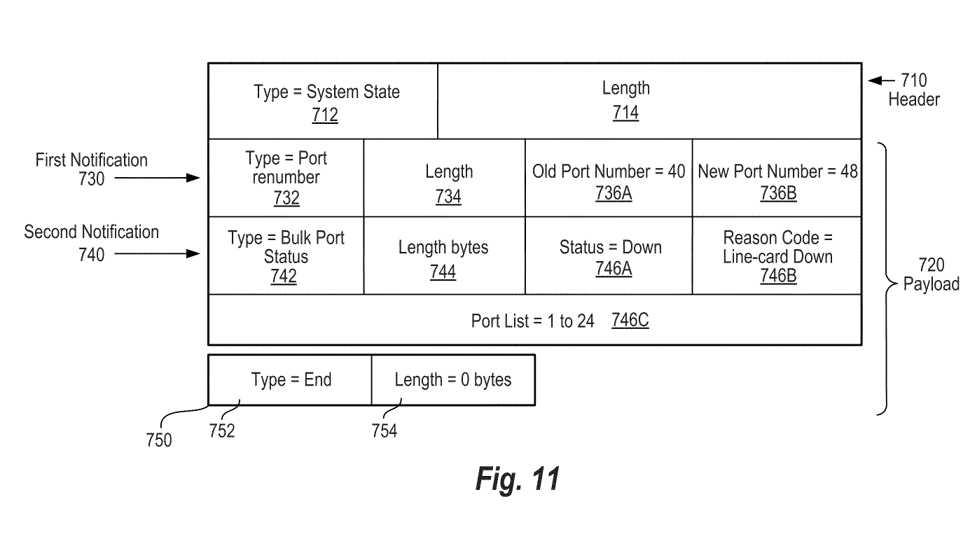

It is possible for a single system state message to include a plurality of system state notifications. FIG. 11 shows an example.

A system state message 700 includes a header 710 and a payload 720. The header may include a message type field 712 indicating that the message communicates system state and a length field 714 indicating the length of the message. The payload 720 may include a plurality of system state notifications; in this example it includes first and second system state notifications 730 and 740.

In the illustrated example the first system state notification 730 is a port re-number notification. It may include a system state type field 732 indicating that it is a port-renumber notification, a length field 734 and a value field including an old port number sub-field 736A and a new port number sub-field 736B. The second system state notification 740 may follow immediately afterwards and in this example is a bulk port status notification. It may include a system state type field 742 indicating that it relates to a bulk port status; a length field 744 and a value field. The value field may include a port status sub-field 746A, a reason field 746B and a port list sub-field 746C.

While there are two system state notifications in the above example, there may in other cases be only one or more than two system state notifications. The system state notifications may relate to different types of system state as in the above example, or some or all of them may relate to the same type of system state. For instance, a first system state notification may relate to a port re-number operation for a first port, while a second system state notification may relate to a port re-number operation for a second port.

The system state message may have an end section to indicate to the controller that the system state message has ended. That way the controller may know that there a no more system state notifications to parse from that message.

In FIG. 11 the system state message has an end section 750. The end section indicates the end of the system state message. Various structures of end section are possible. It may have a type field indicating that it is an end section and in some cases may have other fields. In the example of FIG. 11 the end section 750 includes a type field 752 indicating that it is the end of the message and a length field 754 indicating zero bytes, i.e. that there is not a value field and that there are no further bytes following the length field 754.

In other examples the system state message may not have an end section. In that case the controller may for instance determine when a message has ended from a message length field in the message header.

As can be seen from the above examples, in some implementations a system state message according to the present disclosure may flexible in terms of the information it can convey, but also economic and compact in size. For instance, in some examples the message may only include information relating to system state of the network device and not include other information about network topology or contents of the network device forwarding table. Further, in some examples the system state message may only include information about system state attributes which have changed. This may help to keep the system state message short and relatively quick to transmit and process for both the network device and the controller. When a system state message can be transmitted and processed quickly, this helps both the network device and controller to respond to system state changes in a timely fashion and modify forwarding tables relatively promptly if necessary.

The above examples of system state attributes and corresponding system state notifications all relate to a port or ports of the network device. However, it is possible to have system state notifications relating to system state attributes that are not related to a port. Thus it is possible to have a system state messages in which some or all of the system state information communicated by the message does not relate to a port but relates to another feature or component of the network device.

Examples of system state notifications which do not relate to a port are given below. Any of the system state notifications described in this disclosure may be sent alone in a system state message or in combination with any of the other system state notifications described herein.

System State Relating to Component Failure

System state notifications according to the present disclosure may provide information on a component status. The component may be a component of the network device other than a port. The status may for example indicate a component failure. In the context of this disclosure, a port having a down status is not a component failure.

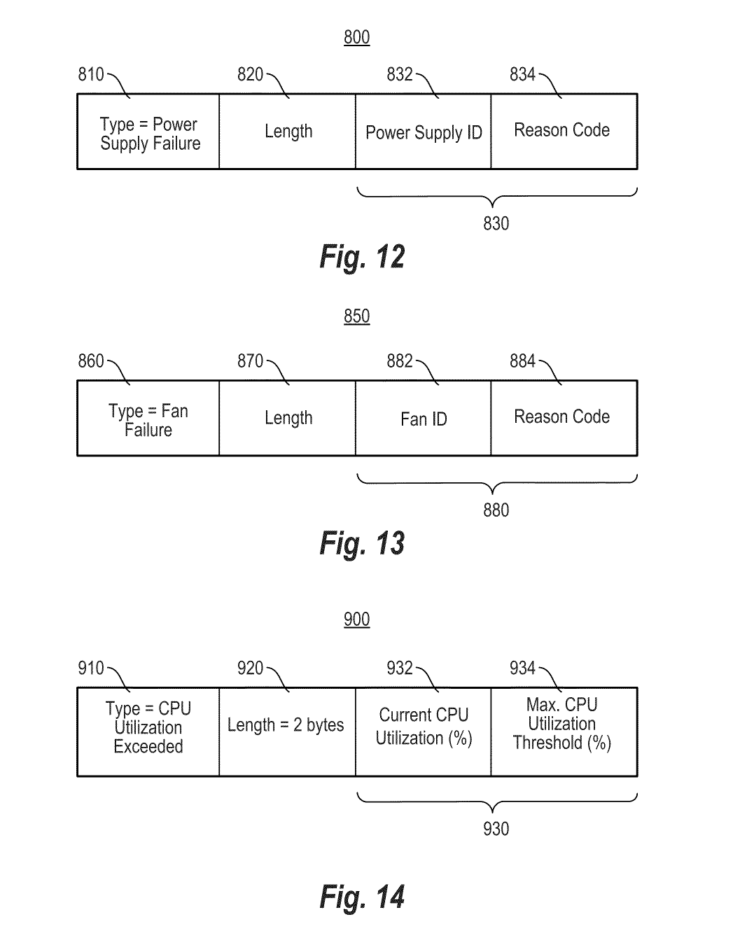

FIG. 12 shows an example of a system state notification relating to a power supply failure. The notification 800 includes a system state type field 810 indicating that the notification relates to a power supply failure and a value field 830. It may also include a notification length field 820 indicating the length of the notification. The value field 830 may include a power supply ID sub-field 832 indicating the ID of the power supply which has failed and may also include a reason sub-field 834 indicating a reason for the failure. The network devices may use multiple power supplies. If one or more of the power supplies fails, it may affect the network device to handle higher loads. Therefore this is an event which it can be helpful the controller to be made aware of by sending a system state message.

FIG. 13 shows an example of a system state notification relating to a fan failure. The notification 850 includes a system state type field 860 indicating that the notification relates to a fan failure and a value field 880. It may also include a notification length field 870 indicating the length of the notification. The value field 880 may include a fan ID sub-field 882 indicating the ID of the fan which has failed and may also include a reason sub-field 884 indicating a reason for the failure.

Network devices use fans to dissipate the heat generated in their chassis. If one or more fans fail, the operating temperature of the network device may rise. This may lead to the shutdown of a module of the network device, or even shutdown of the entire network device. Therefore it can be helpful to inform the controller of such an event, as it may have consequences for the forwarding ability of the network device.

System State Relating to System Resources

System state notifications according to the present disclosure may relate to utilization of system resources. For example the notification may indicate a utilization level (in absolute terms or relative to maximum capacity) or an alert when a certain utilization level is exceeded. In response to such a notification, the controller may modify forwarding policies in order to load balance, avoid bottlenecks or avoid overload of a network device port or component.

In this disclosure the term “system resources” refers to any component of the network device. For example a memory, the CPU, a backup CPU, an ASIC, a cache for buffering packets etc. This type of system state notification may for instance be used if the network device has exceeded minimum memory or CPU or packet/buffer thresholds required for efficient operation. In some cases if a particular system resource is continued to be consumed at a rate above a particular threshold, the network device may stall and become completely non-functional. If a controller is informed of this by a system state message, then the controller may be able to make traffic re-routing decisions based on this information and relieve the network device from handling more and more load.

FIG. 14 shows a system state notification relating to utilization level of a network device processor (e.g. CPU). The notification includes a system state type field 910 indicating that the notification relates to utilization level of a component and a value field 930. The type field 910 may also indicate the particular type of component (e.g. a CPU in this example). The notification may also include a notification length field 920 indicating the length of the notification. The value field 930 includes information relating to the utilization of the component. For example, the value field 930 may include a current component utilization sub-field 932 indicating the current level of utilization of the component, and a maximum utilization sub-field 934 indicating a maximum recommended utilization of the component.

System State Relating to Network Device Configuration or Capability

System state notifications according to the present disclosure may relate to a configuration or capability, or a change in configuration or capability, of a network device. The term “configuration” of a network device means anything in the configuration or indicative of the configuration of the network device which may affect its forwarding capability or the way in which it forwards flows, for example a VLAN which the network device supports, the system time of the network device, a client authentication status of a client with the network device, a network device fabric error count etc. A “capability” of the network device means any network function which the network device as a whole supports, for example PoE (Power over Ethernet), IEEE 802.D, Egress via multiple ports etc.

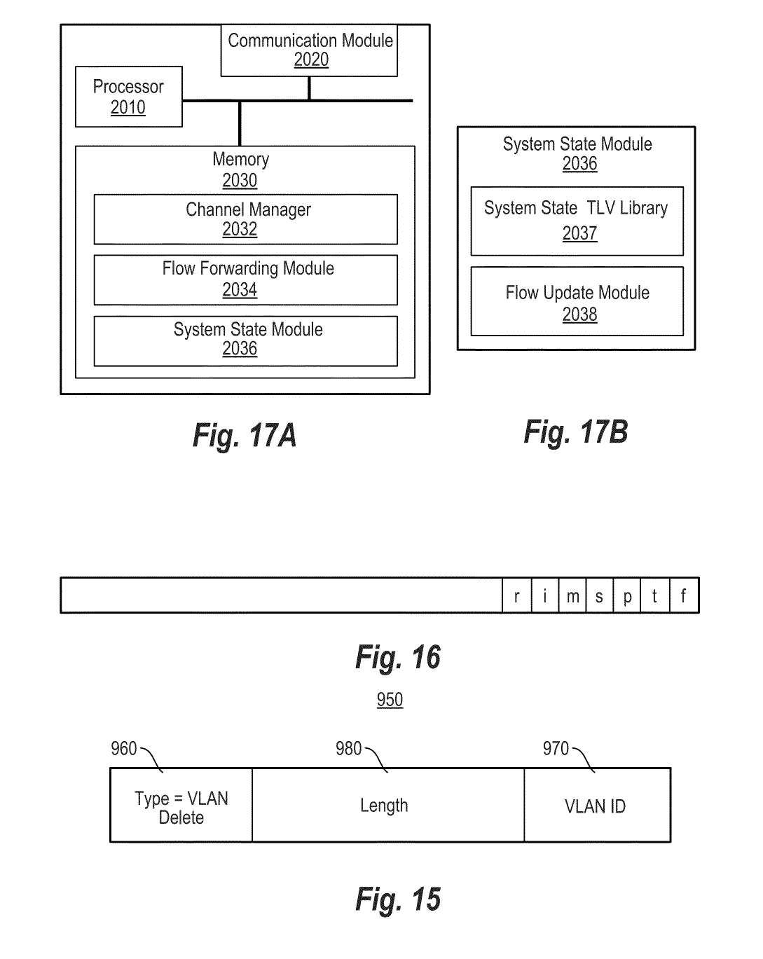

FIG. 15 shows an example of a system state notification relating to a VLAN of the network device. In particular it relates to deletion of a VLAN and may be communicated when a VLAN is removed from the network device.

The notification 950 includes a system state type field 960 indicating that the notification relates to deletion of a VLAN and a value field 970 indicating the ID of the VLAN which had been deleted. The notification may also include a notification length field 960 indicating the length of the system state notification.

For example, if a network device as a flow entry with a VLAN based action rule for packets of a particular VLAN, and the network device is later removed from that VLAN, upon finding this out the controller may delete or modify that flow entry.

The above is just one example and other types of network device configuration or status attributes may be communicated by system state notifications. Various further examples are given below.

For example, a system state notification may communicate a change of PoE (Power over Ethernet) capability of the network device. PoE capability may be affected or disabled by some network device operations and it can be helpful to inform the controller of such an event.

In another example a system state notification may communicate a system time change. The network device's forwarding table flow entries may have an expiry time associated with them. If the system time were to change on the network device, this may impact the flow expiry times. Some network devices are able to handle this, for instance by adjusting the expiry times, while other network devices may not be able to handle this automatically. In either case, it can be helpful to inform the controller of a system time change.

In another example a system state notification may communicate client authentication status. For example, if a host or client connected to each other over a network, via the network device, failed to authenticate for any reason, the controller may determine to reroute traffic to the client via a different route. For instance a new route which does not include the network device. However, in order to do this the controller needs to be made aware of the authentication failure, so a system state message to communicate this can be useful.

In another example a system state notification may communicate network device fabric error counts. Such errors, especially in large number, may be an indication of some kind of issue with the network device backplane. For example, such an issue may be caused by oversubscription on the network device backplane or CRC errors caused by some PKT corruption etc. The controller may take remedial action once it knows that a network device has this issue, for example by reducing the traffic load on the network device and/or routing some traffic flows around or away from the network device.

System State Message Capability Flag

In some implementations it possible that only some of the SDN network devices in a network have the capability to support system state messages. In that case a SDN network device may communicate to the SDN controller that it has this capability by sending a network device capability message to the controller. For instance such a message may be sent by the network device when it first establishes a SDN channel link to the controller.

One possible implementation of such a message is shown in FIG. 16 which shows one example of an OpenFlow specification message with network device capability flags. Flags i, m, s, p, t and f are in the current OpenFlow specification and indicate IPv4 reassembly support, Egress via multiple ports support, IEEE 802.D support, Port Statistics support, Table statistics support and Flow statistics support respectively. The “r” flag is a proposed new flag which indicates that the network device supports system state messages as described in the present disclosure.

SDN Network Controller

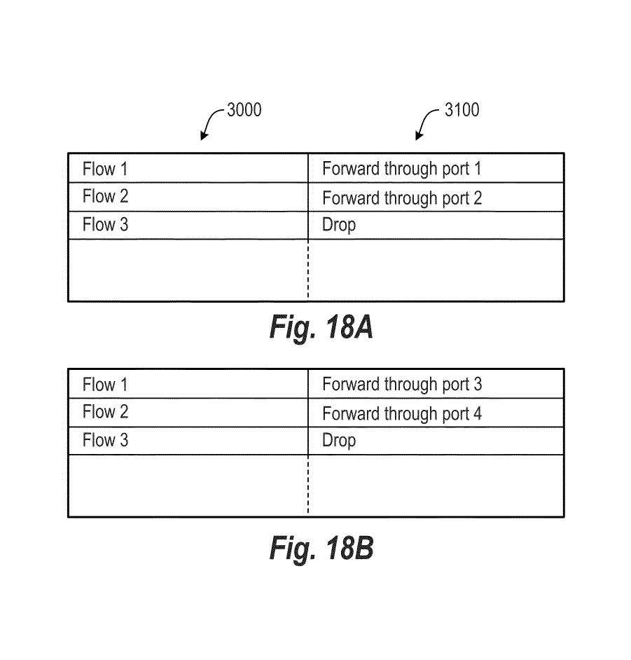

FIG. 17A shows an example structure of a SDN controller 20 according to the present disclosure. The controller may be a computing device such as a server. The controller 20 includes a processor 2010, a communications module 2020 and a memory or non-transitory storage medium 2030. The communications module 2020 may for example include a port such as an Ethernet port to facilitate connection to a network. The memory 2030 stores modules of machine readable instructions which are executable by the processor 2010. The modules of machine readable instructions include a channel manager 2032, a flow forwarding module 2034 and a system state module 2036. The memory in which the machine readable instructions are stored may be a volatile or non-volatile memory or storage media including by way of example semiconductor memory devices, e.g., EPROM, EEPROM, DRAM and flash memory devices; magnetic disks, e.g., internal hard disks or removable disks; magneto optical disks; and CD ROM and DVD-ROM disks.

The channel manager 2032 is to handle communication with a SDN network device over an SDN channel. The flow forwarding module 2034 is to determine a forwarding policy for a network device and to generate instructions for populating or updating a forwarding table of a network device managed by the controller. For example the flow forwarding module 2034 may receive a traffic flow forwarding from a network device which does not know how to forward the traffic flow and may determine a forwarding policy for the traffic flow and inform the network device of the forwarding policy, e.g. by sending instructions to the network device to update its forwarding table with a new entry matching said traffic flow. The system state module 2036 is to receive system state messages from a network device and determine if a network forwarding policy or forwarding table needs to be modified on the basis of the system state information.

FIG. 17B shows an example of one possible implementation of the system state module. The system state module 2036 may include a system state TLV library 2037 defining the system message and notification formats for various types of system state. This library can be used to interpret the meaning of system state messages received by the controller. The system state module 2036 may also include a flow update sub-module 2038 to determine whether a forwarding table of the network device which sent the system state message, or the forwarding table of another network device, needs to be updated in response to the received system state message. The flow update module 2038 may work together with or be part of the flow forwarding module 2034.

Changing of Forwarding Policy

A forwarding policy is a policy for forwarding a flow set by a network device itself or set by a controller for one or more network devices. For example a forwarding policy may include a flow entry or several flow entries in a forwarding table of a SDN network device or flow entries in the flow tables of a plurality of SDN network devices.

FIG. 18A shows an example of a network device forwarding table before a system state message is sent to a SDN controller. The forwarding table may have many entries but only three are shown in FIG. 18A. Each entry includes a flow definition field 3000 and an action field 3100. The forwarding table may also include a statistics field (not shown in FIG. 18A) for gathering data as to how often the flow entry is matched and the number of bytes, packets or flows which it has matched.

The flow definition field 3000 includes a flow definition. If that flow definition is matched by a flow received by the network device, then the network device performs the action specified in the action field 3100 on that flow.

The flow definition may include any information capable of identifying a flow and supported by the SDN protocol, for example it may include any or all of the following sub-fields: VLAN, Port, Ethernet Type, Source MAC (Media Access Control) address, Destination MAC address, Source IP address, Destination IP address, VLAN priority, IP ToS (Type of Service), IP Protocol, Source Port and Destination Port etc sub-fields. These sub-fields may be populated with a particular value to be matched, a range of values or a wildcard indicating that any value will match that sub-field. IP source and IP destination address are commonly by flow entries used to match network flows, while others sub-fields may be used in particular circumstances.

The action field 3100 may specify any action permitted by the SDN protocol. Examples may include forwarding the flow through a specified port, forwarding the flow through a plurality of ports, forwarding a flow to a SDN controller, dropping the flow, modifying a packet header field for packets in the flow or processing packets in the flow in accordance with non-SDN methods.

In the example of FIG. 18A, the forwarding table specifies that a flow matching the definition of flow 1 is to be forwarded through port 1, while a flow matching the definition of flow 2 is to be forwarded through port 2, and a flow matching the definition of flow 3 is to be dropped.

Imagine that ports 1 and 2 change from an up status to a down status. The SDN network device communicates this change in system state to the SDN controller by sending a system state message with a bulk port status notification. In response the SDN controller sends instructions to the SDN network device to modify the flow entries to change the output ports for flows 1 and 2 to ports 3 and 4 respectively. FIG. 18B shows an example of the forwarding table after the network device has updated its forwarding table in accordance with these instructions from the SDN controller.

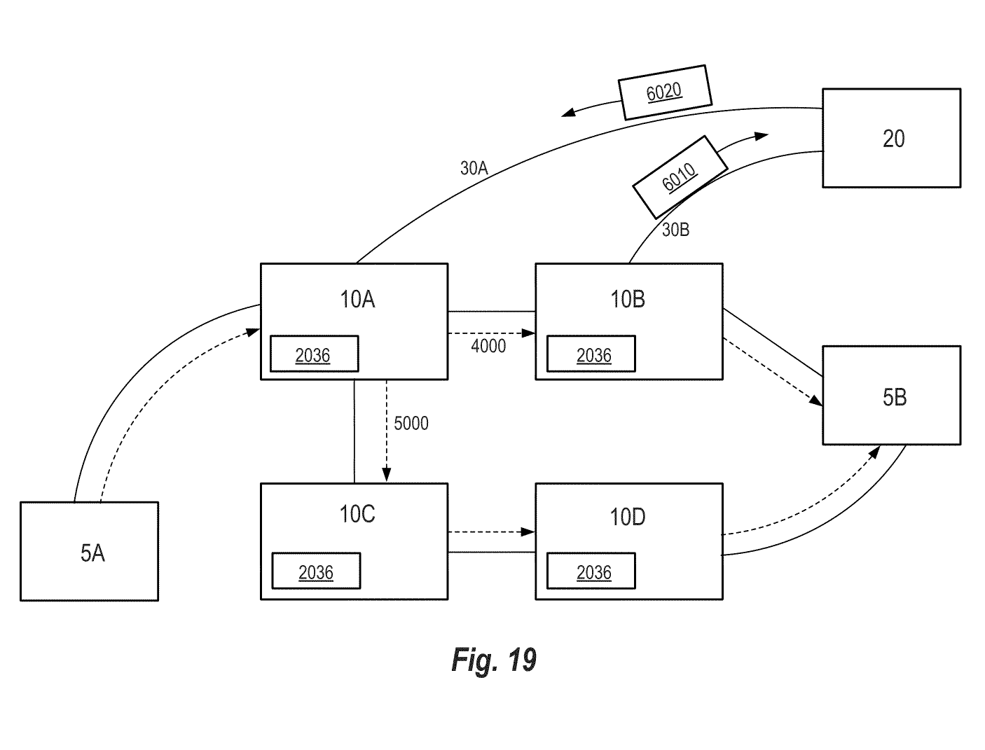

A system state message may cause the SDN controller to determine that a forwarding table of a network device, other than the network device which sent the system state message, should be changed. FIG. 19 shows an example of a network including a first client device 5A which is connected to a second client device 5B over a network including four SDN network devices 10A, 10B, 10C and 10D. Each of the network devices has a system state message module 2036 for sending system state messages to a SDN controller 20. Network devices 10A and 10B communicate with SDN controller 20 over respective SDN channels 30A and 30B. SDN network devices 10C and 10D may communicate with the SDN controller 20 or another SDN controller over their own SDN channels (not shown).

Initially when client device 5A sends a communication to client device 5B, this is transmitted over the network as a traffic flow 4000 shown in dashed lines. Packets in the flow are sent by the client device 5A to SDN network device 10A, the SDN network device 10A forwards the traffic flow to SDN network device 10B and SDN network device 10B forwards the traffic flow to destination client device 5B. The SDN network devices are forwarding the traffic flow in accordance with their forwarding tables.

Subsequently the system state of SDN network device 10B changes in such a way that this route for forwarding traffic may no longer be optimum. This may be due to any one of a variety of changes in system state. For example, perhaps SDN network device 10B is busy with other traffic, or the port which links SDN network device to client 5B is down, or one of the power supplies of network device 10B has failed meaning that it would be desirable to reduce the traffic burden on SDN network device 10B. In any case, SDN network device 10B sends a system state message 6010 to SDN controller 20 informing the controller of its change in system state.

The SDN controller 20 receives the system state message, interprets it and determines that the network forwarding policy should be changed to route this traffic flow via network devices 10C and 10D instead of 10B. Accordingly the controller 20 sends an instruction 6020 to the SDN network device 10A to change its forwarding table entry for this traffic flow so that the flow is forwarded to SDN network device 10C. The traffic flow is then forwarded along path 5000 via SDN network devices 10A, 10C and 10D as indicated by the dotted line. The forwarding tables of SDN network devices 10C and 10D may already know how to forward this traffic flow, but if not then their forwarding tables may also be updated by SDN controller 20, either in response to the system state message 6010, or in response one of these network devices forwarding the traffic flow to the controller as an unknown flow for which a forwarding entry is needed.

Thus it can be seen that a SDN controller may receive a system state message from a SDN network device notifying the SDN controller of a change in system state of that network device. In response the SDN controller may do nothing if no change is needed, or may change the forwarding table of the SDN network device which sent the system state message, or may change the forwarding table of another SDN network device. In some circumstances a SDN controller may receive a system state message from a first SDN network and in response determine that a forwarding table of a second network device should be changed.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for a network device reporting system state to a controller, the method comprising a network device:
determining a system state of the network device;
constructing a system state message including a header and a payload; the header including a message type field indicating that the message relates to system state; the payload including a system state notification comprising a system state type field indicating a type of system state which is being communicated, and a value field indicating a system state value; and
sending the system state message from the network device to the controller over a software defined networking (SDN) protocol channel.

2. The method of claim 1 wherein the SDN protocol channel is an OpenFlow protocol channel.

3. The method of claim 1 wherein the network device sends a system state message to the controller in response to a determination by the network device that a system state of the network device has changed.

4. The method of claim 1 wherein the network device sends a plurality of system state notifications in a single system state message.

5. The method of claim 1 wherein the plurality of system state notifications are followed by a system state message end section indicating that the system state message has finished.

6. The method of claim 1 wherein the system state message comprises information relating to (i) status of a port other than a port up/down status, (ii) status of a network device component other than a port, or (iii) a change in network device configuration or capability.

7. The method of claim 1 wherein the system state information relates to a bulk port status update; a port renumber operation; a VLAN (Virtual Local Area Network) status for a port, a port BFD (Bi-Directional Forwarding Detection) status, or a VLAN ID for a port.

8. The method of claim 1 wherein the system state message comprises information relating to component failure, or
a utilization level of system resources, or
a change in VLAN used by the switch or a change in PoE (Power over Ethernet) capability.

9. The method of claim 1 wherein prior to sending a system state message the network device sends a message to the controller indicating that the network device has the capability to handle system state messages.

10. The method of claim 1 wherein the system state message includes only information about system state attributes which have changed and does not include information about system state attributes which have not changed.

11. A non-transitory computer readable storage medium storing machine readable instructions which are executable by a processor of a SDN (software defined networking) network device to send a system state message to a SDN controller over the SDN protocol channel connecting the SDN network device and the SDN controller; the system state message comprising a message type field indicating that it is a system state message and a payload, the payload comprising a system state type field indicating the type of system state being communicated and a value field providing system state information.

12. The non-transitory computer readable storage medium of claim 11 wherein the instructions include instructions to determine a system state of the SDN network device and construct said system state message based on a determined system state of the SDN network device and wherein said instructions to construct a system state message include instructions to construct a message including said message type field and a system state notification system including said system state type field and said value field.

13. The non-transitory computer readable storage medium of claim 12 wherein the processor is to select a system state notification from a plurality of possible system state notifications, each system state notification relating to a particular system state attribute.

14. A non-transitory computer readable storage medium storing instructions which are executable by a processor of a SDN (software defined networking) controller to:—
receive and decode a system state message, said system state message having been sent to the SDN controller by a SDN network device over a SDN protocol channel, said system state message including a header indicating that it is a system state message and a payload including a system state type field indicating one of a plurality of possible system state types and a system state value field indicating a system state of the SDN network device which sent the system state message;
and make a determination as to whether to update a forwarding policy in response to system state information included in said system state message.

15. The non-transitory computer readable storage medium claim 14 wherein the forward policy includes a forwarding entry of a forwarding table of the SDN network device which sent the system state message, or a forwarding entry of the forwarding table of a SDN network device other than the SDN network device which sent the system state message.
